(19) United States
(12) Patent Application Publication
(10) Pub. No.: US 2012/0125180 A1
(43) Pub. Date: May 24, 2012

(54) DIGITAL PIANO WITH DOCK FOR A HANDHELD COMPUTING DEVICE

(75) Inventor: Brian R. Shim, Providence, RI (US)

(73) Assignee: ION Audio, LLC, Cumberland, RI (US)

(21) Appl. No.: 13/274,745

(22) Filed: Oct. 17, 2011

Related U.S. Application Data
(60) Provisional application No. 61/416,891, filed on Nov. 24, 2010.

(51) Int. Cl. G10H 1/36; G10H 1/32

(52) U.S. Cl. 84/666; 84/670

(57) ABSTRACT

A digital piano having a dock for a handheld computing device is disclosed. The digital piano includes a keyboard having a number of keys and at least one speaker. A sound engine is operative to make audio signal in response to key presses on the plurality of keys of the keyboard. The sound engine includes an audio output to transmit the audio signal. A dock is configured and arranged to connect to a handheld computing device. The handheld computing device has an audio port and a music program running thereon operative to play musical accompaniment to the pianist. A summing circuit is provided that has an input electrically connected to the audio port of the handheld computing device and audio output of the sound engine and an output electrically connected to the at least one speaker.

### CROSS-REFERENCE TO RELATED APPLICATION

The present patent document claims priority to earlier filed U.S. Provisional Patent Application Ser. No. 61/416,891, filed on Nov. 24, 2010, the entire contents of which are incorporated herein by reference.

### BACKGROUND OF THE INVENTION

1. Field of the Invention

The present patent document relates generally to digital pianos and synthesizers and more particularly to a digital piano having an integrated docking port for a portable computing device

2. Background of the Related Art

Digital pianos are well known in the art. However, in today's rapidly evolving technology, prior art digital pianos have several limitations. Specifically, prior art digital pianos lack an ability to connect and interact with handheld computing devices, such as Apple®'s iPad®.

Prior art digital pianos also have other undesirable limitations. For instance, digital pianos have limited capability to provide music accompaniment to the piano player. Often these prior art digital pianos have ten or fewer preset songs that are not selected by the pianist. Accordingly, there is a perceived need in the industry for an ability of a digital piano to not only output the audio of the digital piano, but also provide accompaniment to the digital piano for the pianist of whatever music the pianist desires.

Many digital pianos lack the capability to record and play back the piano player's performance. Recording of MIDI events and audio sound is a desirable feature to enable students to improve their skills on the piano and hobbyists and professionals to record and transfer audio and MIDI events to computers and other audio equipment for further processing. Accordingly, there is also a perceived need in the industry for the ability to record and capture audio from a digital piano to a handheld computing device.

Also digital pianos lack the ability to display music notation in an easily readable format to the pianist. Pianists are accustomed to reading from sheet music in a paper book format to play a prearranged piece of music. Paper sheet music, though, must be turned page by page. Accordingly, there is a perceived need in the industry for the ability to replace paper sheet music with sheet music stored in an electronic format, yet retains the familiarity of paper sheet music. Also, there is a perceived need for a device to enable a pianist to see music notation in an interactive context while playing the digital piano.

### SUMMARY OF THE INVENTION

The digital piano of the present invention solves the problems of the prior art by providing a digital piano that includes a dock configured and arranged to connect to a handheld computing device.

Among the objects of the present invention is the provision for a digital piano that can record audio and MIDI events to a handheld computing device.

Another object of the present invention is the provision for a digital piano that is configured to interact with a handheld computing device to display interactive sheet music to the pianist.

Another object of the present invention is the provision for a digital piano that is configured to play accompaniment for the pianist.

### BRIEF DESCRIPTION OF THE DRAWINGS

These and other features, aspects, and advantages of the present invention will become better understood with reference to the following description, appended claims, and accompanying drawings where:

FIG. 1 is perspective view of an embodiment of the digital piano of the present invention with a handheld computing device docked thereto;

FIG. 2 is a system diagram of an embodiment of the digital piano of the present invention;

FIG. 3 is a system diagram of an alternative second embodiment of the digital piano of the present invention; and

FIG. 4 is a system diagram of an alternative third embodiment of the digital piano of the present invention.

### DESCRIPTION OF THE PREFERRED EMBODIMENT

Referring now to FIG. 1, the digital piano of the present is shown generally at 10 with a handheld computing device 12, such as an Apple® iPad®, connected thereto via a serial interface. Audio output from the handheld computing device 12 is connected to one or more speakers 14 of the digital piano 10. MIDI playback and recording to the handheld computing device 12 from a keyboard 16 of the digital piano 10 may be enabled. Audio recording from an audio output of the digital piano 10 to the handheld computing device 12 may also be enabled. Furthermore, the digital piano 10 may further include a foot pedal 18 configured and arranged to turn or advance a “page” of sheet music on a display of the handheld computing device 12.

The digital piano 10 may be further configured to provide power to the handheld computing device 12 and may be further configured to charge a battery of the handheld computing device 12.

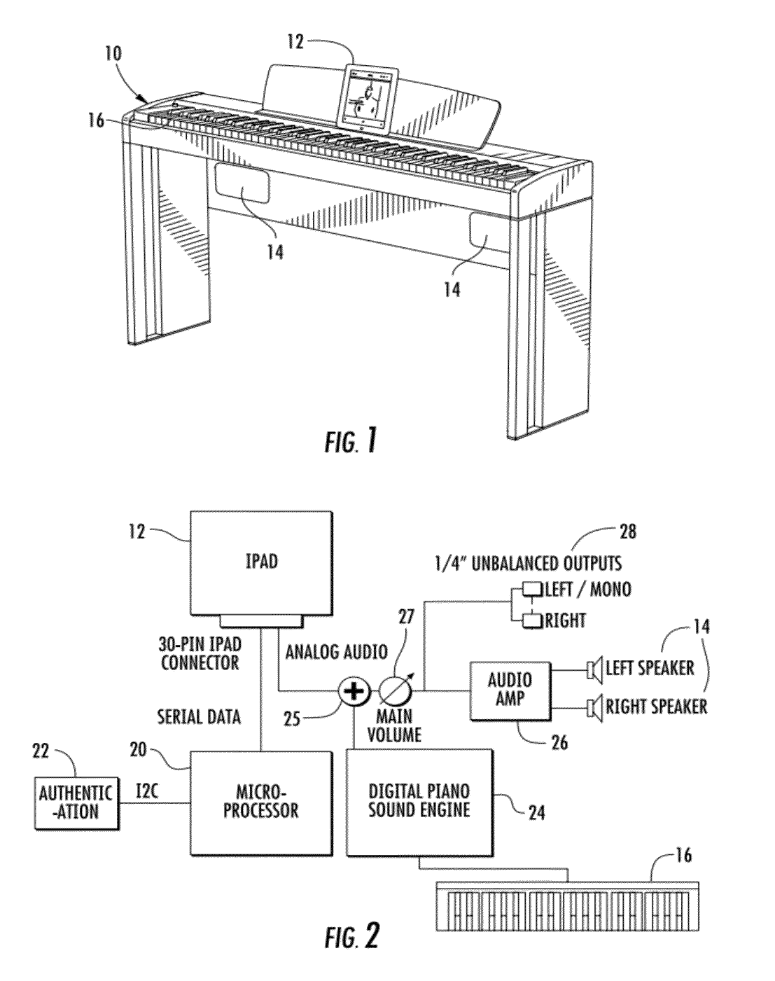

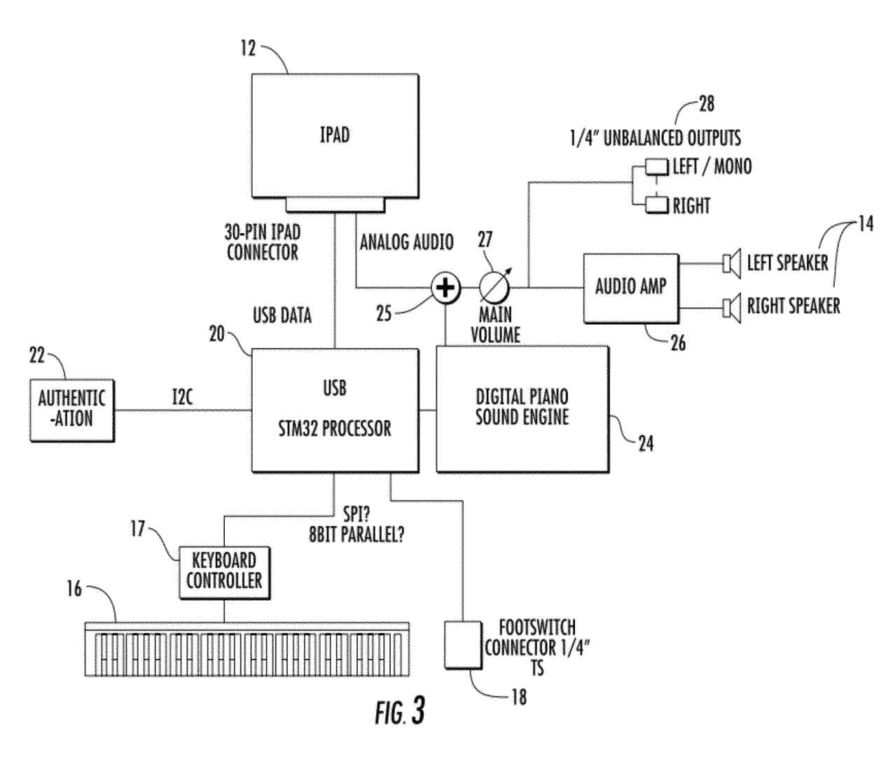

Referring now to FIG. 2, a first embodiment of the digital piano 10 of the present invention is shown generally. In the first embodiment audio output from the handheld computing device 12 is routed to one or more speakers 14 of the digital piano 10. In this embodiment, the stereo audio from the handheld computing device 12 may be played through the digital piano's speakers 14 in order to provide accompaniment to the digital piano 10.

A microprocessor 20 on the digital piano 10 may communicate with an authentication chip 22 (if required) and with the handheld computing device 12 serial interface in order to authorize use of the analog output of the handheld computing device 12. The microprocessor 20 may then initiate stereo audio playback on the handheld computing device 12. The stereo audio is transmitted through an analog audio output of the handheld computing device 12. A sound engine 24 on the digital piano 10 generates analog audio corresponding to key presses on the keyboard 16. Analog audio from the sound engine 24 is summed with the analog output of the handheld computing device 12 via a summing circuit 25. The summed audio of the sound engine 24 and handheld computing device 12 are played through the main audio output (i.e. the speakers 14 or the line outputs 28) of the digital piano 10. The mixed signal may be further amplified by an amplifier 26 on the digital piano 10 and played out the digital piano's speakers 14. An optional main volume control 27 may also be included prior to the amplifier 26. The digital piano 10 may also have one or more line unbalanced outputs 28 for connecting to other gear or external amplifiers to the digital piano 10.

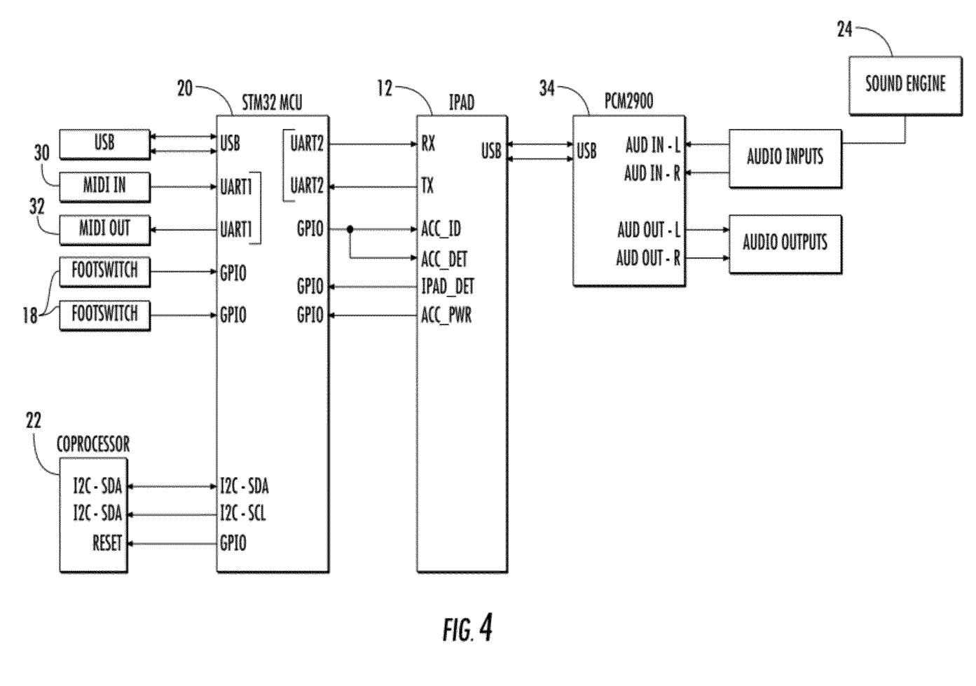

Referring now to FIG. 3, an alternative second embodiment of the digital piano 10 of the present invention is shown generally. In the second embodiment, analog audio from the handheld computing device may be routed to the digital piano's speakers 14 as described above. Furthermore, the second embodiment is further configured to transmit presses on the keyboard 16 of the digital piano 10 to the handheld computing device 12. Specifically, the digital piano 10 may send and receive key press information from the keyboard 16 keys to and from the handheld computing device 12. Preferably, the key press information is sent in MIDI protocol format. However, other protocols may be used. In the second embodiment, pressing a key on the keyboard 16 triggers sounds and events in the handheld computing device 12. Also, the handheld computing device 12 may be configured to trigger sounds in the digital piano 10 as well. Additionally, the pianist's performance on the digital piano 10 may be stored and played back from the handheld computing device 12. One skilled in the art would appreciate this method is an ideal way for pianists to review their own performance. The resulting recorded performance may then be subsequently edited to eliminate errors and make other changes to the composition using audio editing software on the handheld computing device 12 or on a personal computer.

More specifically, the digital piano 10 includes a microprocessor 20 which may be connected to an authentication chip 22 (if required) to authorize use of the analog output of the handheld computing device 12, in order to enable audio output and MIDI protocol communication (or other serial communication protocol). The microprocessor 20 (which could be an STM32, but could be a variety of other devices) is connected to the serial connector of the handheld computing device 12. The keyboard 16 is connected to a keyboard controller 17, which sends key press information, which is preferably MIDI note data, to the microprocessor 20. The microprocessor 20 also sends and receives MIDI note data to and from a sound engine 24 of the digital piano 10. When the digital piano's keys 16 are played, MIDI note data is sent from the digital piano 10 to the microprocessor 20, which transmits it to the handheld computing device 12. The handheld computing device 12 can also send MIDI note data to the microprocessor 20, which transmits the MIDI note data on to the sound engine 24 for play back. In this embodiment, the keyboard 16 does not send key press information directly to the sound engine 24.

Alternatively, the keyboard 16 may be electrically connected to the sound engine 24 as the first embodiment shown in FIG. 2 instead of passing through the microprocessor 20.

Like the first embodiment shown in FIG. 2, the second embodiment may also play musical accompaniment for the pianist. The audio port of the handheld computing device 12 and audio output of the sound engine 24 are connected to a summing circuit 25 to allow both audio outputs to be combined together. The combined audio output may then be played out the speakers 14 or transmitted out the line outputs 28. The second embodiment may also include a main volume control 27 and amplifier 26 located between the summing circuit 25 and speakers 14.

As mentioned earlier, a foot pedal 18 may be provided. Input form the foot pedal 18 is transmitted to the microprocessor 20, which is configured to transmit foot pedal 18 information to the handheld computing device 12. The foot pedal 18 may be a “sustain” pedal or other type of music control pedal known in the art. In addition, the foot pedal 18 may be configured to cause the handheld computing device 12 to advance the “page” of sheet music presented on the display of the handheld computing device 12. The pianist may display sheet music on the display of the handheld computing device 12. When the pianist presses the foot pedal 18, the microprocessor 20 transmits the foot pedal press event to the handheld computing device 12. In response to receiving the pedal foot press event from the microprocessor 20, the handheld computing device 12 advances the sheet music to the next page to permit the pianist to continue playing a prearranged piece of music.

Referring now to FIG. 4, an alternative third embodiment is shown. In addition to the features described above for the first and second embodiments, the third embodiment may also record audio to the handheld computing device 12.

The digital piano 10 includes a MIDI input 30 and a MIDI output 32 that are connected to the sound engine 24 (not shown in this drawing) of the digital piano 10. MIDI note events from the digital piano 10 may be transmitted to the handheld computing 12 device from the MIDI output 32, and played back from the handheld computing device 12 through the MIDI input 30. In addition, the audio from the digital piano 10 may be recorded into the handheld computing device 12 through the audio inputs on the handheld computing device. Similarly, audio may be played out from the handheld computing device 12 through audio outputs on the handheld computing device 12 to the digital piano's speakers 14. In this embodiment, audio is passed through to the handheld computing device 12 via a universal serial bus controller 34 with integrated audio CODEC (“USB Audio Controller”). The USB Audio Controller 34 may be integrated with the microprocessor 20 as shown in FIG. 3 and described above for the second embodiment.

The microprocessor 20 may be further configured to transmit pedal information to the handheld computing device 12. The foot pedal 18 may be a sustain pedal or other type of music control pedal known in the art. In addition, the foot pedal 18 may be configured to cause the handheld computing device 12 to advance the “page” of sheet music on the display of the handheld computing device 12. The pianist may display sheet music on the display of the handheld computing device 12. When the pianist presses the foot pedal 18, the microprocessor 20 transmits the foot pedal press event to the handheld computing device 12. In response to receiving the foot pedal press event from the microprocessor 20, the handheld computing device 12 advances the sheet music to the next page to permit the pianist to continue playing a prearranged piece of music.

Therefore, it can be seen that the present invention provides a unique solution to the problem of providing a digital piano that includes the ability to interact with a handheld computing device.

It would be appreciated by those skilled in the art that various changes and modifications can be made to the illustrated embodiments without departing from the spirit of the present invention. All such modifications and changes are intended to be within the scope of the present invention.

What is claimed is:

1. A digital piano, comprising:
a keyboard having a plurality of keys;
a sound engine operative to make an audio signal in response to key presses on the plurality of keys of the keyboard, the sound engine having an audio output to transmit the audio signal;
a dock configured and arranged to connect to a handheld computing device, the handheld computing device having an audio port and a music program running thereon operative to play musical accompaniment to the pianist; and
a summing circuit having an input electrically connected to the audio port of the handheld computing device and audio output of the sound engine and an output electrically connected to the at least one speaker.

2. The digital piano of claim 1, wherein the keyboard is electrically connected to the sound engine.

3. The digital piano of claim 1, further comprising a microprocessor electrically connected to the keyboard, the microprocessor configured and arranged to received key presses from the plurality of keys and convert the key presses into note data and transmit therefrom;

4. The digital piano of claim 3, wherein the sound engine is configured and arranged to make audio in response to note data received from a microprocessor.

5. A digital piano, comprising:
a keyboard having a plurality of keys;
at least one speaker;
a microprocessor electrically connected to the keyboard, the microprocessor configured and arranged to received key presses from the plurality of keys and convert the key presses into note data and transmit therefrom;
a dock configured and arranged to connect to a handheld computing device, the handheld computing device having a music program running thereon operative to capture note data sent from the microprocessor;
a sound engine operative to make an audio signal in response to key presses on the plurality of keys of the keyboard, the sound engine having an audio output to transmit the audio signal; and
a summing circuit having an input electrically connected to the audio port of the handheld computing device and audio output of the sound engine and an output electrically connected to the at least one speaker.

6. A digital piano, comprising:
a keyboard having a plurality of keys;
at least one speaker;
a sound engine electrically connected to the keyboard and operative to make an audio signal in response to key presses on the plurality of keys of the keyboard, the sound engine having an audio output to transmit the audio signal;
a dock configured and arranged to connect to a handheld computing device, the handheld computing device having an audio port and a music program running thereon operative to play musical accompaniment to the pianist; and
a summing circuit having an input electrically connected to the audio port of the handheld computing device and audio output of the sound engine and an output electrically connected to the at least one speaker.

7. A digital piano, comprising:
a keyboard having a plurality of keys;
at least one speaker;
a sound engine electrically connected to the keyboard and operative to make an audio signal in response to key presses on the plurality of keys of the keyboard, the sound engine having an audio output to transmit the audio signal;
a microprocessor electrically connected to the keyboard, the microprocessor configured and arranged to received key presses from the plurality of keys and convert the key presses into note data and transmit therefrom;
a dock configured and arranged to connect to a handheld computing device, the handheld computing device having a music program running thereon operative to capture note data sent from the microprocessor;
a summing circuit having an input electrically connected to the audio port of the handheld computing device and audio output of the sound engine and an output electrically connected to the at least one speaker.

8. A digital piano, comprising:
a keyboard having a plurality of keys;
at least one speaker;
a microprocessor electrically connected to the keyboard, the microprocessor configured and arranged to received key presses from the plurality of keys and convert the key presses into note data and transmit therefrom;
a dock configured and arranged to connect to a handheld computing device, the handheld computing device having a music program running thereon operative to capture note data sent from the microprocessor;
a sound engine operative to make audio in response to note data received from the microprocessor, the sound engine having an audio output; and
a summing circuit having an input electrically connected to the audio port of the handheld computing device and audio output of the sound engine and an output electrically connected to the at least one speaker.

9. The digital piano of claim 8, further comprising a foot pedal electrically connected to the microprocessor, said microprocessor configured and arranged to convert foot pedal presses into note data.

10. The digital piano of claim 8, wherein said note data is in MIDI format.

11. The digital piano of claim 8, wherein said music program running on said handheld computing device is configured and arranged to play accompaniment music.

12. The digital piano of claim 8, wherein said music program running on said handheld computing device is configure and arranged to save note data received from said microprocessor and play back said note data on demand.

13. The digital piano of claim 8, wherein said music program running on said handheld computing device is configure and arranged to display sheet music.

14. The digital piano of claim 13, wherein said music program running on said handheld computing device is configure and arranged to turn the page of said sheet music upon receipt of note data corresponding to a foot pedal press.

15. The digital piano of claim 8, wherein said music program running on said handheld computing device is configure and arranged to record audio from the sound engine to the handheld computing device.

16. The digital piano of claim 8, further comprising an audio amplifier electrically connected between the at least one speaker and the summing circuit.

17. The digital piano of claim 8, further comprising left and right stereo outputs.

18. The digital piano of claim 8, further comprising a main volume control electrically connected between said summing circuit and said at least one speaker.

12. The digital piano of claim 8, wherein said microprocessor is configured and arranged to be electrically connected to said handheld computing device via a serial date connection.

19. The digital piano of claim 8, wherein said microprocessor is configured and arranged to be electrically connected to said handheld computing device via a universal serial data bus connection.
